(19) United States
(12) Patent Application Publication
(10) Pub. No.: US 2004/0077800 A1
(43) Pub. Date: Apr. 22, 2004

(54) Composition for protective film, method of using the same, and use thereof

(76) Inventors: Chie Umeyama, Saitama (JP); Masaki Shinmoto, Saitama (JP)

Correspondence Address: Kevin S Lemack, Nields & Lemack, Suite 8, 176 E Main Street, Westboro, MA, 01581, US

(21) Appl. No.: 10/468,242

(22) PCT Filed: Feb. 20, 2002
(86) PCT No.: PCT/JP02/01449

(30) Foreign Application Priority Data
Feb. 23, 2001 (JP) 2001-47670

(51) Int. Cl. C08G 59/14

(52) U.S. Cl. 525/523

(57) ABSTRACT

The object of the present invention is to provide a composition for protective films excellent in adhesion and visible light transmittance that can form a protective film having high surface smoothness even on a substrate whose surface has not been smoothed and has extremely high resistance to thermal yellowing without staining liquid crystals. Especially, when used for protective films of color filters for liquid-crystal displays, the protective films have the excellent high-temperature resistance under ITO (yellowing resistance) vapor deposition.

The composition for protective films is characterized by comprising (1) an epoxy resin having at least two epoxy groups in one molecule, (2) apolyphenol compound having a cyclic terpene skeleton, and (3) an imidazole-type curing promoter.

### TECHNICAL FIELD

The present invention relates to a composition for forming protective films, in particular to the one favorable for protective films on colored films (for example, colored resin films) formed on the surfaces of glass substrates, etc.

### BACKGROUND ART

In the process of fabricating, liquid-crystal display devices, they are dipped in solvent, acid, alkali solution, etc. In addition, the surfaces of the devices are locally exposed to high temperature during sputtering for ITO formation thereon. For preventing the devices from being deteriorated and damaged under such severe conditions, generally formed thereon is a protective film that is resistant to such treatments. In addition to the above-mentioned requirement for it, the protective film is further required to satisfy the following requirements: It does not stain liquid crystals. Its surface is smooth. Its adhesiveness to the substrate on which the protective film is formed and also to the layer to be formed on the protective film is good. Its visible light transmittance is high, so that it does not lower the brightness of liquid crystal displays. It is resistant to aging such as discoloration, whitening, yellowing, etc. It is high enough to resist to impact, stress, etc.

As materials for such protective films, acrylic resin, melamine resin, polyimide resins and others have been proposed. At present, however, no one knows a well-balanced material for these that satisfies all the necessary requirements. For example, acrylic resin has good visible light transmittance but its heat resistance is not enough. Therefore, the resin has a problem that its film surface is creased or cracked while vapor deposition with ITO (indium tin oxide) or the like thereon. Melamine resin has good heat resistance but its adhesiveness to glass substrates is extremely bad. Therefore, the resin has a problem that it is often repelled on substrates or filters. Polyimide resin has good heat resistance but, on the other hand, it has problems that its transparency is not good enough and that its storage stability is not also good and that its solubility low and organic solvents usable for it may corrode color filters. In addition, protective films formed of acrylic resin having an epoxy group or formed by using epoxy resin and an o-cresol-novolak-type curing agent as proposed in JP-A-5-140274 and JP-A-5-140267 have been investigated, but they still have problems that their adhesiveness is insufficient, or, with the increase in the vapor deposition temperature of ITO these days, their yellowing resistance under heat in vapor deposition is not good. To improve the yellowing resistance of the films, an acid anhydride is tried for the curing agent. However, it has problems in storage stability in terms of its reactivity and its moisture absorption. Further, in addition that there is another problem that the organic solvent in which it is dissolved is limited, the solvent has a problem in terms of its safety and the like.

The object of the present invention is to provide a protective film-forming composition which forms a protective film satisfying good adhesiveness and visible light transmittance that have heretofore been required for protective films and having high surface smoothness even on a substrate not having a smooth surface and further having high heat resistance and good yellowing resistance and which does not stain liquid crystals and, especially when the protective film is used for protecting colored resin films of color filters for liquid-crystal displays, it has the excellent resistance under ITO vapor deposition and the composition for it does not stain liquid crystals at all.

### DISCLOSURE OF THE INVENTION

We, the present inventors have assiduously studied to solve the problems mentioned above, and, as a result, have found that an epoxy resin composition which contains a polyphenol compound having a specific skeleton as a curing agent satisfies the above-mentioned properties all at a time, and have completed the present invention. Specifically, the invention relates to the following:

(1) A composition for protective films, which contains (i) an epoxy resin having at least two epoxy groups in one molecule, (ii) a polyphenol compound having a cyclic terpene skeleton, and (iii) an imidazole-type curing promoter;

(2) The composition for protective films of above (1), wherein the polyphenol compound having a cyclic terpene skeleton is a compound made by the addition of two phenol molecules to one cyclic terpene compound molecule;

(3) The composition for protective films of above (1), wherein the polyphenol compound having a cyclic terpene skeleton is a compound obtained by condensing a compound made by the addition of two phenol molecules to one cyclic terpene compound molecule with an aldehyde and/or an ketone in the presence of an acid catalyst;

(4) The composition for protective films of any one of above (1) to (3), wherein the epoxy resin is an alicyclic polyfunctional epoxy resin;

(5) The composition for protective films of any one of above (1) to (3), wherein the polyphenol compound having a cyclic terpene skeleton is derived from at least one or more selected from a group consisting of phenol, o-cresol, 2,6-xylenol and o-allylphenol;

(6) The composition for protective films of above (4), wherein the polyphenol compound having a cyclic terpene skeleton is derived from at least one or more selected from a group consisting of phenol, o-cresol, 2,6-xylenol and o-allylphenol;

(7) The composition for protective films of any one of above (1) to (3), wherein the imidazole-type curing promoter is 2,3-dihydro-1H-pyrrolo-[1,2-a]benzimidazole;

(8) The composition for protective films of above (4), wherein the imidazole-type curing promoter is 2,3-dihydro-1H-pyrrolo-[1,2-a]benzimidazole;

(9) The composition for protective films of above (5), wherein the imidazole-type curing promoter is 2,3-dihydro-1H-pyrrolo-[1,2-a]benzimidazole;

(10) The composition for protective films of above (6), wherein the imidazole-type curing promoter is 2,3-dihydro-1H-pyrrolo-[1,2-a]benzimidazole;

(11) A transparent thin film obtained by using the composition for protective films of anyone of above (1) to (10);

(12) The transparent thin film of above (11) which is a protective film for color filters;

(13) A method of using the composition for protective films of any one of above (1) to (10) as protective films for liquid-crystal display devices;

(14) A liquid-crystal display equipped with a color filter that has the transparent thin film of above (12);

(15) A composition for films of high visible light transmittance, which contains (i) an epoxy resin having at least two epoxy groups in one molecule, (ii) a polyphenol compound having a cyclic terpene skeleton, and (iii) an imidazole-type curing promoter.

### BEST MODES OF CARRYING OUT THE INVENTION

The invention is described in detail hereinunder. Unless otherwise specifically indicated in the following, “%”and “part” are all by mass.

The epoxy resin having at least two epoxy groups in one molecule (polyfunctional epoxy resin) for use in the invention includes, for example, polyfunctional epoxy resins that are glycidyl-etherified compounds of polyphenol compounds; polyfunctional epoxy resins that are glycidyl-etherified compounds of various novolak resins; and alicyclic polyfunctional epoxy resins, aliphatic polyfunctional epoxy resins, heterocyclic polyfunctional epoxy resins, glycidyl ester-type polyfunctional epoxy resins, glycidylamine-type polyfunctional epoxy resins, polyfunctional epoxy resins prepared by glycidylating halogenophenols, etc. One or more of these may be used herein either singly or as combined.

Of those polyfunctional epoxy resins, preferred for use herein are alicyclic polyfunctional epoxy resins which gives sometimes preferable effect to transparency. Among the alicyclic polyfunctional epoxy resins, preferred are those in which the aliphatic ring is a cyclohexane ring having 6 carbon atoms. For example, an epoxy resin using, as an material, a compound obtained by polycondensation compound of 2,2-bis(hydroxyphenyl)-1-butanol and 1,2-epoxy-4-vinylcyclohexane is one preferred example of the epoxy resins. One commercial product of having, preferred alicyclic polyfunctional epoxy resin having the cyclohexane ring, EHPE3150 (hereinafter referred to as epoxy resin A) is available from Daicel Chemical Industry. The alicyclic polyfunctional epoxy resin may be used singly or in combination with any other polyfunctional epoxy resins such as those mentioned hereinabove. As the case may be, the polyfunctional epoxy resin may further be mixed with any other monofunctional epoxy resins, acrylic resins, polyester resins and others within amount that it does not interfere the physical properties such as heat resistance, yellowing resistance and transparency of the coating films to be formed of the composition.

Concrete examples of polyfunctional epoxy resins except the above-mentioned epoxy resin A are mentioned below.

The polyfunctional epoxy resins that are glycidyl-etherified compounds of polyphenol compounds include those of polyphenol compounds such as bisphenol A, bisphenol F, bisphenol S, 4,4′-biphenol, tetramethylbisphenol A, dimethylbisphenol A, tetramethylbisphenol F, dimethylbisphenol F, tetramethylbisphenol S, dimethylbisphenol S, tetramethyl-4,4′-biphenol, dimethyl-4,4′-biphenol, 1-(4-hydroxyphenyl)-2-[4-(1,1-bis-(4-hydroxyphenyl)ethyl)phenyl]propane,

2,2′-methylene-bis(4-methyl-6-tert-butylphenol), 4,4′-butylidene-bis(3-methyl-6-tert-butylphenol), trishydroxyphenylmethane, resorcinol, hydroquinone, pyrogallol, phloroglucinol, diisopropylidene skeleton-having phenols, fluorene skeleton-having phenols such as 1,1-di-4-hydroxyphenylfluorene, polyphenol compounds such as phenolated polybutadiene, etc.

The polyfunctional epoxy resins that are glycidyl-etherified compounds of various novolak resins include those of various novolak resins using, as a material, various phenols such as phenol, cresols, ethylphenols, butylphenols, octylphenols, bisphenols such as bisphenol A, bisphenol F and bisphenol S, and naphthols, as well as xylylene skeleton-having phenol-novolak resins, dicyclopentadiene skeleton-having phenol-novolak resins, biphenyl skeleton-having phenol-novolak resins, and fluorene skeleton-having phenol-novolak resins, etc.

The alicyclic polyfunctional epoxy resins include those having an aliphatic ring skeleton such as cyclohexane. The aliphatic polyfunctional epoxy resins include glycidyl ethers of polyalcohols such as 1,4-butanediol, 1,6-hexanediol, polyethylene glycol, pentaerythritol. The heterocyclic polyfunctional epoxy resins include those having a hetero ring such as isocyanuric ring or hydantoin ring. For the glycidyl ester-type epoxy resins, mentioned are those of carboxylates such as diglycidyl hexahydrophthalate. The glycidylamine-type polyfunctional epoxy resins include glycidylated derivatives of amines such as aniline and toluidine. The epoxy resins of glycidylated halogenophenols include those obtained by glycidylation of halogenophenols such as bromobisphenol A, bromobisphenol F, bromobisphenol S, bromophenol-novolak, bromocresol-novolak, chlorobisphenol S, chlorobisphenol A.

The monofunctional epoxy resins that are optionally used in combination with the polyfunctional epoxy resins include alicyclic monofunctional epoxy resins, aliphatic monofunctional epoxy resins, heterocyclic monofunctional epoxy resins, glycidyl ester-type monofunctional epoxy resins, glycidylamine-type monofunctional epoxy resins, monofunctional epoxy resins obtained by glycidylation of halogenophenols, etc.

In the composition of the invention, it is desirable that as a polyfunctional epoxy resin, an alicyclic polyfunctional epoxy resin is used alone, or an alicyclic polyfunctional epoxy resin is used in combination with any other polyfunctional epoxy resin. Accordingly, in a more preferred composition of the invention, the content ratio of the alicyclic polyfunctional epoxy resin in the entire polyfunctional epoxy resin (100 parts) is preferably from 30 to 100 parts, more preferably from 40 to 100 parts. The balance is some other polyfunctional epoxy resin, and the content may be from 0 to 70 parts, preferably from 0 to 60 parts. The other polyfunctional epoxy resin that is added to the preferable alicyclic polyfunctional epoxy resin is, for example, an epoxy resin obtained by glycidyl etherification of a novolak resin, more preferably a phenol-novolak resin in which the phenol may have substituted (with a hydroxyl group, an alkyl group having from 1 to 3 carbon atoms, etc.).

In the composition of the invention, the amount of the monofunctional epoxy resin, the acrylic resin, the polyester resin or the like that may be optionally added to the polyfunctional epoxy resin is not specifically defined so far as they do not substantially lower the physical properties such as heat resistance, yellowing resistance and transparency of the coating films formed of the composition. In general, however, the amount of the additional resin is within a range of from 0 to 20 parts or so relative to 100 parts by weight of the polyfunctional epoxy resin in the composition.

The polyphenol compound having a cyclic terpene skeleton for use in the invention functions as a curing agent, and it is not specifically limited so far as it has a cyclic terpene skeleton and at least two phenolic hydroxyl groups in the molecule. Specifically, it includes for example, cyclic terpene skeleton-having polyphenol compounds that are obtained by reaction of cyclic terpene compounds with phenols to attain addition of about 2 phenol molecules to one cyclic terpene compound molecule, and compounds obtained by condensation of that the polyphenol compound having a cyclic terpene skeleton with at least one or more selected from a group consisting of aldehydes and ketones in the presence of an acid catalyst (high molecular weight cyclic terpene skeleton-having polyphenol compounds) as those described in detail in Japanese Patent 2,572,293.

The cyclic terpene compounds used as the starting material for the polyphenol compound having a cyclic terpene skeleton include monoterpene compounds (compounds cyclized by bonding two isoprene units with biosynthesis) such as limonene (the following formula (1)); dipentene which is one optical isomer of limonene; α-pinene (the following formula (2)); β-pinene (the following formula (3)); α-terpinene (the following formula (4)); β-terpinene (the following formula (5)); γ-terpinene (the following formula (6)); 3,8-methanediene (the following formula (7)); 2,4-methanediene (the following formula (8)); terpinolene (the following formula (9)).

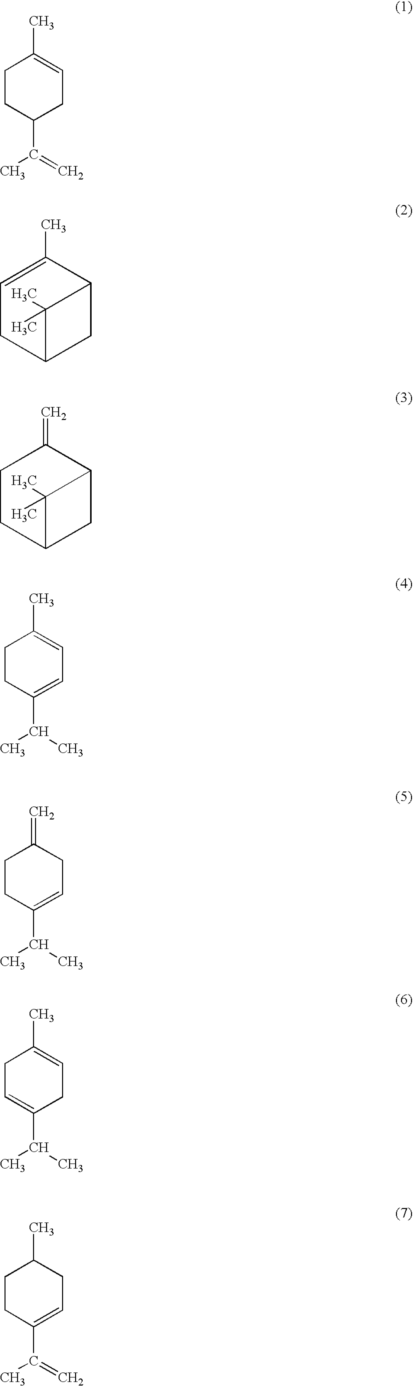

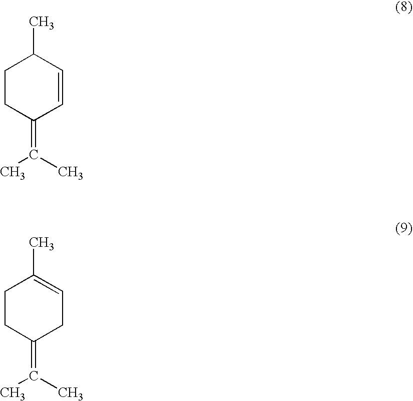

The phenols to be added to the cyclic terpene compounds are, for example, phenols unsubstituted or substituted with any of an alkyl group having from 1 to 3 carbon atoms, an aryl group, a hydroxyl group and the like, such as phenol, o-cresol, 2,6-xylenol and o-allylphenol. Of those, preferred are phenol and o-cresol, and more preferred is phenol.

The reaction may be carried out in the presence of an acid catalyst such as hydrochloric acid, sulfuric acid, phosphoric acid, polyphosphoric acid, boron trifluoride. In general, solvent, such as aromatic hydrocarbons, alcohols, ethers, etc are used.

Thus obtained polyphenol compound having a cyclic terpene skeleton, for example, a reaction product of limonene and phenol is presumed to be a mixture of the compound of the following formulas (I) and (II), and their structures are difficult to identify.

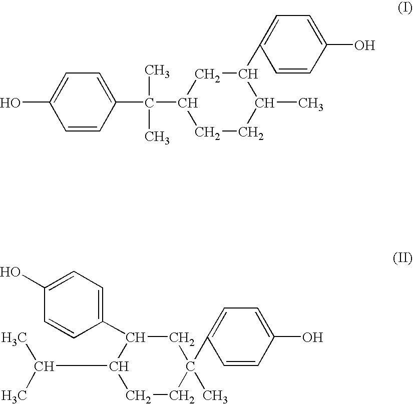

The aldehydes and ketones that are used for producing the high molecular weight polyphenol compound having a cyclic terpene skeleton include aliphatic aldehydes and ketones having from 1 to 6 carbon atoms, such as formaldehyde, paraformaldehyde, acetaldehyde, benzaldehyde, hydroxybenzaldehyde, acetone, cyclohexanone; and benzaldehyde optionally substituted with a hydroxyl group, etc.

The polyphenol compound having a cyclic terpene skeleton functions as a curing agent in the present invention, and it is usually used alone. As the case may be, however, it may be used in combination with any other curing agent. In the combination, said other curing agent is used in such an amount that it does not lower the physical properties such as heat resistance, yellowing resistance and visible light transmittance of the cured products. The curing agent used in the combination includes acid anhydride-type curing agents, carboxylic acid-type curing agents, amine-type curing agents, phenolic curing agents, hydrazide-type curing agents, etc.

Examples of the acid anhydride-type curing agents are aromatic carboxylic acid anhydrides such as phthalic anhydride, trimellitic anhydride, pyromellitic anhydride, benzophenone-tetracarboxylic acid anhydride, ethylene glycol-anhydrous trimellitic anhydride, biphenyltetracarboxylic acid anhydride; aliphatic carboxylic acid anhydrides such as azelaic acid, sebacic acid, dodecane-diacid; and alicyclic carboxylic acid anhydrides such as tetrahydrophthalic anhydride, hexahydrophthalic anhydride, nadic anhydride, HET acid anhydride, himic anhydride.

Examples of amine-type curing agents are aromatic amines such as diaminodiphenylmethane, diaminodiphenyl sulfone, diaminodiphenyl ether, p-phenylenediamine, m-phenylenediamine, o-phenylenediamine, 1,5-diaminonaphthalene, m-xylylenediamine; aliphatic amines such as ethylenediamine, diethylenediamine, isophoronediamine, bis(4-amino-3-methyldicyclohexyl)methane, polyetherdiamine; and guanidines such as dicyanediamide, 1-(o-tolyl)biguamide.

Examples of the phenolic curing agents are bisphenol A, bisphenol F, bisphenol S, 4,4′-biphenylphenol, tetramethylbisphenol A, dimethylbisphenol A, tetramethylbisphenol F, dimethylbisphenol F, tetramethylbisphenol S, dimethylbisphenol S, tetramethyl-4,4′-biphenol, dimethyl-4,4′-biphenylphenol, 1-(4-hydroxyphenyl)-2-[4-(1,1-bis-(4-hydroxyphenyl)ethyl)phenyl]propane,2,2′-methylene-bis(4-methyl-6-tert-butylphenol),4,4′-butylidene-bis(3-methyl-6-tert-butylphenol), trishydroxyphenylmethane, resorcinol, hydroquinone, pyrogallol, diisopropylidene skeleton-having phenols, fluorenone skeleton-having phenols such as 1,1-di-4-hydroxyphenylfluorenone, phenolated polybutadiene; various novolak resins, for example, those prepared from various phenols such as phenol, cresols, ethylphenols, butylphenols, octylphenols, bisphenol A, bisphenol F, bisphenol S or naphthols, xylylene skeleton-having phenol-novolak resins, dicyclopentadiene skeleton-having phenol-novolak resins, biphenyl skeleton-having phenol-novolak resins, fluorene skeleton-having phenol-novolak resins, furan skeleton-having phenol-novolak resins, etc.

Examples of the hydrazide-type curing agents are dihydrazide-type curing agents such as carbodihydrazide, oxalic dihydrazide, malonic dihydrazide, succinic dihydrazide, glutaric dihydrazide, adipic dihydrazide, pimelic dihydrazide, suberic dihydrazide, azelaic dihydrazide, sebasic dihydrazide, dodecanediohydrazide, hexadecanediohydrazide, terephthalic dihydrazide, isophthalic dihydrazide, 2,6-naphthoic dihydrazide, 4,4′-bisbenzenedihydrazide, 1,4-naphthoic dihydrazide, 2,6-pyridinedihydrazide, 1,4-cyclohexanedihydrazide, tartaric dihydrazide, malic dihydrazide, iminodiacetic dihydrazide, N,N′-hexamethylenebissemicarbazide, itaconic dihydrazide; and polyfunctional hydrazide-type curing agents such as pyromellitic trihydrazide, ethylenediaminetetraacetic tetrahydrazide, 1,2,4-benzenetrihydrazide.

The amount of the curing agent to be in the composition is generally from 0.2 to 1.8, preferably from 0.4 to 1.4, more preferably from 0.6 to 1.2 in terms of the equivalent ratio of the functional group in the curing agent to the epoxy group in the epoxy resin.

In the invention, the imidazole-type curing promoter is a preferred curing promoter. If desired, it may be used in combination with any other compound known as a catalyst that promotes epoxy resin curing, for example, tertiary amines and phosphines in an amount of not interfering with the physical propertie. As the imidazole-type curing promoter, usable are various imidazole compounds, for example, 2-methylimidazole, 2-ethyl-4-methylimidazole, 2-phenylimidazole, 2-undecylimidazole, 2-heptadecylimidazole, 2-phenyl-4-methylimidazole, 1-benzyl-2-phenylimidazole, 1-benzyl-2-methylimidazole, 1-cyanoethyl-2-methylimidazole, 1-cyanoethyl-2-phenylimidazole,1-cyanoethyl-2-undecyl imidazole,2,3-dihydro-1H-pyrrolo-[1,2-a]benzimidazole, 2,4-diamino-6-(2′-methylimidazole(1′))ethyl-s-triazine, 2,4-diamino-6-(2′-undecylimidazole(1′))ethyl-s-triazine, 2,4-diamino-6-(2′-ethyl,4-methylimidazole(1′))ethyl-s-triazine, 2,4-diamino-6-(2′-methylimidazole(1′))ethyl-s-triazine/isocyanuric acid adduct, 2-methylimidazole/isocyanuric acid 2/3 adduct, 2-phenylimidazole/isocyanuric acid adduct, 2-phenyl-3,5-dihydroxymethylimidazole, 2-phenyl-4-methyl-5-hydroxymethylimidazole, and 1-cyanoethyl-2-phenyl-3,5-dicyanoethoxymethylimidazole. Among them, catalysts that predominantly promote the reaction of epoxy group and phenolic hydroxyl group are preferred, for example, 2,3-dihydro-1H-pyrrolo-[1,2-a]benzimidazole is more preferred.

The amount of the imidazole-type curing promoter to be used in the composition is generally at least 0.1 parts, preferably at least 0.3 parts, more preferably at least 0.5 parts, but at most 7 parts, preferably at most 5 parts, more preferably at most 4 parts, even more preferably at most 3.5 parts, relative to 100 parts of the epoxy resin. If the amount of the imidazole-type curing promoter is too small, the composition could not be sufficiently crosslinked and the heat resistance of the protective film formed will be poor; but if too large, the storage stability of the composition and the yellowing resistance thereof in curing and the property thereof of not staining liquid crystals may be lower.

If desired, various additives may be added to the composition for protective films of the invention. They include a coupling agent, a surfactant, an antioxidant, a light stabilizer, a wet resistant, a thixotropic agent, a defoaming agent, any other resin, a tackifier, an antistatic agent, a lubricant, a UV absorbent, etc.

Examples of the coupling agent usable herein are silane coupling agents such as 3-glycidoxypropyltrimethoxysilane, 3-glycidoxypropylmethyldimethoxysilane, 3-glycidoxypropylmethyldimethoxysilane, 2-(3,4-epoxycyclohexyl)ethyltrimethoxysilane, N-(2-aminoethyl)-3-aminopropylmethyldimethoxysilane, N-(2-aminoethyl)-3-aminopropylmethyltrimethoxysilane, 3-aminopropyltriethoxysilane, 3-mercaptopropyltrimethoxysilane, vinyltrimethoxysilane, N-(2-(vinylbenzylamino)ethyl)-3-aminopropyltrimethoxysilane hydrochloride, 3-methacryloxypropyltrimethoxysilane, 3-chloropropylmethyldimethoxysilane, 3-chloropropyltrimethoxysilane; titanium coupling agents such as isopropyl (N-ethylaminoethylamino)titanate, isopropyl triisostearoyltitanate, titanium di(dioctylpyrophosphate) oxyacetate, tetraisopropyl di(dioctylphosphite)titanate, neoalkoxytri(p-N-(β-aminoethyl)aminophenyl) titanate; zirconium or aluminium coupling agents such as Zracetylacetonate, Zr methacrylate, Zr propionate, neoalkoxy zirconate, neoalkoxytrisneodecanoyl zirconate, neoalkoxytris(dodecanoyl)benzenesulfonyl zirconate, neoalkoxytris(ethylenediaminoethyl) zirconate, neoalkoxytris(m-aminophenyl) zirconate, ammonium zirconium carbonate, Al acetylacetonate, Al methacrylate, Al propionate. Among them, silane coupling agents are preferred; and silane coupling agents having epoxy group are more preferred. By use of such a coupling agent, the adhesiveness to substrates increases to give protective film having good wet resistance reliability.

The amount of the coupling agent may be from 0.1 to 5 parts, preferably from 0.5 to 4 parts or so, relative to 100 parts of the epoxy resin.

The surfactant is added for improving the coatability of the composition for protective films. For example, silicone surfactants and fluorine-containing surfactants are used and the amount to be added is generally from 0.001 to 0.5 parts, preferably from 0.08 to 0.3 parts relative to 100 parts by weight of the epoxy resin.

The composition for protective films of the invention may be obtained as varnish, by uniformly dissolving the epoxy resin, the curing agent, the imidazole-type curing promoter and optionally various additives in an organic solvent. In general, the varnish may be prepared so that its solid content could be at least 10%, preferably at least 15%, more preferably at least 20%, but at most 50%, preferably at most 40%, more preferably at most 35% or so. The concentration of the varnish may be suitably adjusted according to the epoxy resin composition. In consideration of the efficiency of its coating for films, the varnish may be so prepared that its viscosity at 25° C. may be from 2 to 30 mpa·s, preferably from 4 to 15 mpa·s.

Examples of the organic solvent are alcohols such as methanol, ethanol, propanol, butanol, preferably lower alcohols having from 1 to 4 carbon atoms; glycol ethers such as ethylene glycol monomethyl ether, ethylene glycol monoethyl ether, ethylene glycol monobutyl ether, propylene glycol monomethyl ether, 3-methoxybutanol, 3-methyl-3-methoxybutanol, preferably lower ethers having from 1 to 4 carbon atoms of alkylene glycols having from 1 to 4 carbon atoms; alkylene glycol ether acetates such as ethylene glycol monoethyl ether acetate, ethylene glycol monobutyl ether acetate, propylene glycol monomethyl ether acetate, propylene glycol monoethyl ether acetate, 3-methoxybutyl acetate, 3-methyl-3-methoxybutyl acetate, ethyl ethoxypropiolate, preferably lower ether acetates having from 1 to 4 carbon atoms of alkylene glycols having from 1 to 4 carbon atoms; aromatic hydrocarbons such as toluene, xylene; ketones such as methyl ethyl ketone, cyclohexanone, cyclopentanone, 4-hydroxy-4-methyl-2-pentanone; esters such as methyl acetate, ethyl acetate, propyl acetate, butyl acetate, methyl 2-hydroxy-2-methylpropionate, ethyl 2-hydroxy-2-methylpropionate, methyl hydroxyacetate, ethyl hydroxyacetate, butyl hydroxyacetate, methyl lactate, ethyl lactate, butyl lactate, methyl 3-hydroxypropionate, ethyl 3-hydroxypropionate, propyl 3-hydroxypropionate, butyl 3-hydroxypropionate, propyl 2-hydroxy-3-methylbutanoate, ethyl methoxyacetate, propyl methoxyacetate, methyl ethoxyacetate, ethyl ethoxyacetate, propyl ethoxyacetate, butyl ethoxyacetate, methyl 2-methoxypropionate, ethyl 2-methoxypropionate, propyl 2-methoxypropionate, butyl 2-methoxypropionate, methyl 2-ethoxypropionate, ethyl 2-ethoxypropionate, propyl 2-ethoxypropionate, butyl 2-ethoxypropionate, methyl 3-methoxypropionate, ethyl 3-methoxypropionate, propyl 3-methoxypropionate, butyl 3-methoxypropionate, methyl 3-ethoxypropionate, ethyl 3-ethoxypropionate, propyl 3-ethoxypropionate, butyl 3-ethoxypropionate, preferably C1-C4 alkyl esters of fatty acids having from 2 to 4 carbon atoms and optionally substituted with a hydroxyl group and/or a lower alkyl group having from 1 to 4 carbon atoms; ethers such as tetrahydrofuran, etc.

Among those, preferred are C1-C4 lower ether acetates of alkylene glycols having 2 or 3 carbon atoms, such as propylene glycol monomethyl ether acetate, propylene glycol monoethyl ether acetate, ethylene glycol monobutyl ether acetate, and also propylene glycol monomethyl ether, 3-methoxybutanol, 3-methyl-3-methoxybutanol and esters, in consideration of the solubility therein of the epoxy resin, the curing agent and the curing promoter, the reactivity of the components with the organic solvent, the time-dependent viscosity change owing to evaporation, the toxicity to human bodies, etc.

The amount of the organic solvent to be used is not specifically defined. It may be suitably adjusted according to the desired thickness of the films and the surface smoothness thereof, and the film-forming method to give good coatability.

The coating films formed of the composition of the invention thus obtained has good adhesiveness to various materials such as glass, wood, metals and plastics and has good surface smoothness, heat resistance, yellowing resistance, transparency and toughness. Therefore, they are useful, for example, as various protective films, especially as coating films (coating films of high visible light transmittance therein) in the area that requires high visible light transmittance such as in organic EL devices and plasma display panels. In addition, since the composition does not stain liquid crystals, it is especially useful in forming protective films on colored resin films such as color filters for liquid-crystal displays, or in forming smooth layers of color filters for liquid-crystal displays. In this case, the thin transparent films formed by curing the composition for protective films of the invention are effective for preventing liquid crystals from being stained by ionic impurities that may be released from color filters.

In case where the coating film is used for protective films such as those for color filters, the coating is carried out by spin coating. The coating is so controlled that the thickness of the film after heating and curing may be from 0.1 to 10 μm, preferably from 0.5 to 8 μm. For efficient coating operation, the viscosity at 25° C. of the composition is controlled to be at least 2 mPa·s, preferably at least 4 mPa·s, more preferably at least 5 mPa·s, but at most 30 mPa·s, preferably at most 15 mPa·s, more preferably at most 13 mPa·s generally by controlling the amount of the organic solvent to be added to the composition. After the coating operation, the drying and curing condition shall be optimized depending on the blend ratio of the components in the composition solution and on the type of the solvent used. In general, the coating layer is pre-baked at 70 to 100° C. to remove the solvent and then post-baked at 150 to 250° C. for 10 minutes to 1.5 hours to cure. The curing temperature may not be constant. For example, the coating layer may be cured while the temperature is elevated. The pre-baking for solvent removal and the post-baking for curing may be carried out using an oven, a hot plate, etc.

The color filter thus coated with the protected film of the invention (the transparent thin film of the invention) in the manner as above may be favorably used in liquid-crystal display devices, etc. An ordinary liquid-crystal display device comprises a color filter part (optionally having an ITO film or an ITO pattern), a liquid crystal part, a backlight part and a polarizing film part. The invention therefore provides such a liquid-crystal display device using the color filter having the protective film of the invention.

### EXAMPLE

The invention is described more specifically with reference to the following Examples, to which, however, the invention is not limited.

### Example 1

A composition for protective films, having the composition shown in the column of Example 1 in Table 1 (the numeral data are in terms of “parts”), was dissolved in propylene glycol monomethyl ether acetate to prepare a solution for protective films having a solid concentration of 25% and having a viscosity of 5.2 mPa·s (measured with an R-type viscometer at 10 rpm). Next, this was applied onto a glass substrate having a thickness of 0.7 mm by a spin coater in such a manner that the thickness of the cured film thereof could be 2 microns, and then pre-baked at 100° C. for 2 minutes and thereafter cured at 220° C. for 20 minutes to obtain a transparent thin film of the invention. The test results of the transparent thin film thus obtained are given in Table 2 (the test methods are described below).

### Examples 2 and 3, Comparative Examples 1 and 2

Transparent thin films were formed in the same manner as in Example 1 except that the compositions shown in the columns of Examples 2 and 3 and Comparative Examples 1 and 2 in Table 1 were used as a composition for protective films. The test results of these films are given in Table 2.

### Examples 4 to 6

Protective films were formed in the same manner as in Example 1 except that the compositions shown in the columns of Examples 1 to 3 in Table 1 were used as a composition for protective films and micropatterned color filters (glass substrates with a colored resin film formed thereon) were used in place of the glass substrate. The test results of these films are given in Table 3.

TABLE 1

| | Comparative |
|---|---|
| Example | Example |

| | 1 | 2 | 3 | 1 | 2 |
|---|---|---|---|---|---|
| Epoxy Resin A | 100 | 50 | 100 | 100 | 100 |
| Epoxy Resin B | | 50 | | | |
| Curing Agent A | 88 | 83 | | 88 | |
| Curing Agent B | | | 94 | | |
| Curing Agent C | | | | | 58 |
| Promoter A | 3 | 3 | 2 | | 2 |
| Promoter B | | | | 3 | |
| Coupling Agent | 2 | 2 | 2 | 2 | 2 |
| Surfactant | 0.1 | 0.1 | 0.1 | 0.1 | 0.1 |

In Table 1:

Epoxy resin A: polyfunctional cyclohexane-epoxy resin having an epoxy group on the cyclohexane ring (epoxy equivalent: about 180 g/eq) (trade name: EHPE3150, by Daicel Chemical Industry).

Epoxy resin B: orthocresol-novolak epoxy resin (epoxy equivalent: 201 g/eq) (trade name: EOCN-1020-80, by Nippon Kayaku).

Curing agent A: terpene skeleton-having diphenol (hydroxyl equivalent: 158 g/el, softening point: 120° C.) (trade name: YP-90 (high-purity grade), by Yasuhara Chemical). Curing agent B: novolak-type terpene skeleton-having phenol resin (hydroxyl equivalent: 170 g/eq) (trade name: Epicure MP402FPY, by Japan Epoxy Resin).

Curing agent C: phenol-novolak resin (hydroxyl equivalent: 105 g/eq) (trade name: HF-1, by Meiwa Chemical).

Promoter A: 2,3-dihydro-1H-pyrrolo-[1,2-a]benzimidazole Promoter B: triphenylphosphine (phosphorus-containing curing promoter by Hokko Chemical).

Coupling agent: epoxysilane-type coupling agent, Sila-Ace S-510 (by Ajinomoto).

Surfactant: fluorine-containing surfactant, Megafac F470 (by Dai-Nippon Ink).

TABLE 2

| Example | | | Comp. Example | |
|---|---|---|---|---|
| 1 | 2 | 3 | 1 | 2 |

Yellowing
Resistance

| | | | | | |
|---|---|---|---|---|---|
| 230° C. | ∘∘ | ∘∘ | ∘∘ | ∘∘ | x |
| 240° C. | ∘ | ∘ | ∘ | ∘ | x |
| Liquid Crystal | ∘ | ∘ | ∘ | x | x |
| Staining Resistance | | | | | |
| (retention) | 23.7% | 28.1% | 25.9% | 0.86% | 4.95% |
| Tg/DMA | 240° C. | 228° C. | 259° C. | 225° C. | 217° C. |

TABLE 3

| | | Example | | |
|---|---|---|---|---|
| | | 4 | 5 | 6 |
| Yellowing Resistance | 230° C. | ∘∘ | ∘∘ | ∘∘ |
| | 240° C. | ∘ | ∘ | ∘ |

In Table 1 to Table 3, the tests methods and the evaluation standards are as follows:

1. Heat Resistance Test (Test for Yellowing of Coating Film):

The protective film formed was kept in an oven at 230° C. or 240° C. for 30 minutes, and visually checked for yellowing. Thus tested, the film was compared with the original film before the heat treatment, and evaluated for the yellowing resistance thereof. ∘∘ indicates no change at all; ∘ indicates little change; and x indicates yellowing and impracticable.

2. Test for Resistance to Staining Liquid Crystals:

The protective film formed was scraped off with a cutter knife, and 50 mg thereof was put into 50 g of a standard sample of liquid crystal. This was left as such at 100° C. for 72 hours, and the specific resistivity of the supernatant liquid crystal was measured. ∘ indicates little resistivity reduction; and x indicates that a resistivity reduction of at least 10 times the original one.

In addition, the liquid crystal alone was heated in the same manner as above, and its specific resistivity (B) was measured. From the specific resistivity (A) of the supernatant liquid crystal, and the specific resistivity (B) of the liquid crystal alone, the specific resistivity retention was calculated according to the following equation, and shown in Table 2.

Retention=(A/B)×100(%).

3. Measurement of Glass Transition Temperature:

In Table 1, the solvent was removed from each composition of Examples 1 to 3 and Comparative Examples 1 and 2, and the residual composition was kneaded with a hot roll, transfer-molded and post-cured at 220° C. for 20 minutes. The glass transition temperature (Tg) of the thus-prepared sample was measured through DMA (differential mechanical analysis with Rheograph Solid by Toyo Seiki; heating rate 2° C./min). The transfer-molding condition was 175° C. and 5 minutes.

### INDUSTRIAL APPLICABILITY

The composition for protective films of the invention is highly transparent and does not stain liquid crystals, and is highly resistant to heat. Therefore, it is advantageous for protecting colored resin films, especially effective for improving the reliability of color liquid-crystal display devices.

1. A composition for protective films, which contains
(1) an epoxy resin having at least two epoxy groups in one molecule,
(2) a polyphenol compound having a cyclic terpene skeleton, and
(3) an imidazole-type curing promoter.

2. The composition for protective films as claimed in claim 1, wherein the polyphenol compound having a cyclic terpene skeleton is a compound made by the addition of two phenol molecules to one cyclic terpene compound molecule.

3. The composition for protective films as claimed in claim 1, wherein the polyphenol compound having a cyclic terpene skeleton is a compound obtained by condensing a compound made by the addition of two phenol molecules to one cyclic terpene compound molecule followed by condensing it with an aldehyde and/or an ketone in the presence of an acid catalyst.

4. The composition for protective films as claimed in any one of claims 1 to 3, wherein the epoxy resin is an alicyclic epoxy resin.

5. The composition for protective films as claimed in any one of claims 1 to 3, wherein the polyphenol compound having a cyclic terpene skeleton is derived from at least one or more selected from a group consisting of phenol, o-cresol, 2,6-xylenol and o-allylphenol.

6. The composition for protective films as claimed in claim 4, wherein the polyphenol compound having a cyclic terpene skeleton is derived from at least one or more selected from a group consisting of phenol, o-cresol, 2,6-xylenol and o-allylphenol.

7. The composition for protective films as claimed in any one of claims 1 to 3, wherein the imidazole-type curing promoter is 2,3-dihydro-1H-pyrrolo-[1,2-a]benzimidazole.

8. The composition for protective films as claimed in claim 4, wherein the imidazole-type curing promoter is 2,3-dihydro-1H-pyrrolo-[1,2-a]benzimidazole.

9. The composition for protective films as claimed in claim 5, wherein the imidazole-type curing promoter is 2,3-dihydro-1H-pyrrolo-[1,2-a]benzimidazole.

10. The composition for protective films as claimed in claim 6, wherein the imidazole-type curing promoter is 2,3-dihydro-1H-pyrrolo-[1,2-a]benzimidazole.

11. A transparent thin film obtained by using the composition for protective films of any one of claims 1 to 10.

12. The transparent thin film as claimed in claim 11 which is a protective film for color filters.

13. A method of using the composition for protective films of any one of claims 1 to 10 for protective films as liquid-crystal display devices.

14. A liquid-crystal display equipped with a color filter that has the transparent thin film of claim 12.

15. A composition for films of high visible light transmittance, which contains (i) an epoxy resin having at least two epoxy groups in one molecule, (ii) a polyphenol compound having a cyclic terpene skeleton, and (iii) an imidazole-type curing promoter.
